(19) United States
(12) Patent Application Publication
(10) Pub. No.: US 2019/0073624 A1
(43) Pub. Date: Mar. 7, 2019

(54) Rapid Roadside Rescue System and Payment Fulfilment Platform

(71) Applicants: Lee Thomas Schaeffer, Plano, TX (US); James Patrick Clayton, Dublin, TX (US); William Jennings Dearien, Frisco, TX (US); James Nelson Dearien, II, Dallas, TX (US)

(72) Inventors: Lee Thomas Schaeffer, Plano, TX (US); James Patrick Clayton, Dublin, TX (US); William Jennings Dearien, Frisco, TX (US); James Nelson Dearien, II, Dallas, TX (US)

(21) Appl. No.: 15/695,181

(22) Filed: Sep. 5, 2017

(51) Int. Cl. G06Q 10/08; G06Q 20/32; G06Q 30/06

(52) U.S. Cl. CPC G06Q 10/083; G05D 1/0202; G06Q 30/0643; G06Q 20/325

(57) ABSTRACT

The present invention employs software, communication links and various Systems to expedite the purchase and delivery of items or services commonly used to assist stranded motorist(s) and/or disabled vehicles, manned or otherwise, through an automated Unmanned Aerial Vehicle (also identified herein as a UAV) dispatch, or by dispatching another type vehicle, and a Payment Fulfilment Platform distributed to serve a plurality of locations through the use of a communication device or plurality of communication devices. This software transmits request(s) for service by permitting a Customer, to select and/or change selections such as price, fuel grades, a particular service, parts and payment methods, as examples, prior to registering a dispatch to Vendor(s) on the System. The present invention is configured to expeditiously facilitate service(s) and/or product(s) from Vendor(s) to Customer(s).

### FIELD OF THE INVENTION

The present invention relates to roadside relief and assistance particularly pertaining to new Systems, software and other Systems that most typically assist the owner or operator of a disabled vehicle, manned or otherwise, for various reasons, more efficiently and quickly, than current or traditional road based delivery methods.

### DESCRIPTION OF THE PRIOR ART

The utilization of roadside rescue via road based service is known in the prior art. More specifically, a human operated road based motor vehicle loaded with various replacement parts, fuel and towing equipment that responds to the phone call from the location of a motorist stranded in a disabled vehicle. In some cases, the stranded motorist, or Customer, cannot always locate a trustworthy service provider who can travel to the stranded motorist of a disabled vehicle. Drivers or owners of the disabled vehicle may also have difficulty determining which provider is closest to the vicinity of the disabled vehicle. Furthermore, for various reasons, the closest provider might not always be able to reasonably provide the fastest or cost effective solution.

When someone calls for roadside assistance they may expect the assistance requested to arrive within a reasonable period of time. However some, or all, organizations, such as car clubs or automobile dealerships, as examples, might not be capable of delivering products or services, or a wide variety of services or products, to stranded motorists within a particular time period due to road hazards or poor road conditions, heavy traffic control, road congestion, a backlog of work and/or availability of employees and/or traditional motor vehicles such as a tow truck or fully loaded service vehicle, as examples. Accordingly, new Systems, devices, methodologies and software may be implemented by offering Vendors equipped with UAV's able to transport a product(s) or service(s) ‘above the road’ to assist Customers (e.g., drivers and/or passengers of disabled vehicles) in particular service regions, an opportunity to participate.

### SUMMARY OF THE INVENTION

In light of the foregoing background, the following presents a simplified summary of the present disclosure in order to provide a basic understanding of some aspects of the invention. This summary is not an extensive overview of the invention. It is not intended to identify key or critical elements of the invention or to delineate the scope of the invention. The following summary merely presents concepts of the invention in a simplified form as a prelude to the more detailed description provided below.

The present invention offers the user menu-type options with a swift means to assist and inform the Customer, most typically the operator or owner of a stranded vehicle, manned or otherwise, on selecting a service, product and/or payment option before making the request. Each System participant operates independently and therefore is unaffected by geographical relationship to one another. Accordingly, what is needed in the field is a computerized UAV summoning platform which functions independently from other participants and can send information to or request information from a variety of Vendors for a variety of services or products. The System would contain specialized software which prompts the user for such information including, but not limited to, the language desired to initiate, process and complete the transaction, how to order a particular product or service, such as high-octane gasoline or the amount of fuel desired, or anything else necessary to solve the Customer's problem. The approximate cost for delivery of the product or service provided could then be calculated and displayed and the System would be capable of receiving and processing payment of the promised service or product, with an electronic ticket issued to participants in the transaction.

Aspects of the disclosure also address one or more of the issues mentioned above by disclosing methods, computer readable storage media, software, structure and apparatuses for providing a roadside assistance System that may deliver service, diagnosis, fuel, parts, instructions and delivery of any other payload necessary to solve the Customer's problem within a certain period of time from a variety of Vendors. In particular, the System may facilitate transactions between Vendor(s) and the Customer(s) where Employees and/or Systems of that Vendor load UAVs, or another type of vehicle, whether the selected UAV is owned or managed by the Vendor, whether the selected UAV is owned or managed by the Customer or whether the selected UAV is owned or managed by a plurality of participating parties, with the items ordered and are processed through the Payment Fulfilment Platform by said Customer before the order is initiated and a delivery vehicle is dispatched. The System uses a telecommunication or satellite link to relay the request to the dispatcher while an electronic ticket is transmitted to participants in the transaction. Further, the System facilitates broader ranges of Customer service by offering the process in multiple languages. The System may include computing, reading and scanning devices, software (e.g. GPS tracking and location services) and service vehicles as well as network computing devices (e.g., computing devices such as a server).

The System may receive a service request or order from the Customer, then identify the appropriate Vendor(s), to assist the Customer before the Customer finalizes their request. The System may select the appropriate Vendor(s), based on Vendor's hours of operation, brand of fuel favored by Customer, type of fuel required by vehicle, current availability, reported operational status, types of delivery vehicles in Vendor's fleet in relation to Customer's requirements, location of the disabled vehicle represented by (e.g., GPS coordinates of a mobile computing device or vehicle computing device associated with the disabled vehicle or as the location may be provided by the Customer) or for a plurality of other reasons. In an example, the System may show the Customer Vendors nearest to the disabled vehicle or may show the Customers Vendors further away from the disabled vehicle with larger, more powerful UAVs capable and available of delivering a larger, heavier product or payload, even though the Vendor(s) with the larger, more powerful UAV are located farther away from the disabled vehicle. Therefore, Vendors participating in the System may choose to advertise and/or promise a particular response while providing a particular service(s) or product(s) or product line(s) for a particular region or area (e.g. 5 gallons of premium gasoline on a particular stretch of highway X in less than 15 minutes).

Aspects of this disclosure provide a System comprising a first computing device associated with a first vehicle (e.g. a mobile computing device of a driver of the first vehicle) and a second series of computing devices associated with a Vendor or plurality of Vendors (e.g. a computing device of the Vendor(s)). The Vendor(s), and/or any other parties participating in the transaction, may be established in traditional locations based on traffic flow where fuel, and other products and services such as mechanical services or towing, are offered to the general public or at any other location the Vendor desires. The first and second computing devices may be, for example, a smartphone, tablet, etc. device installed in a vehicle or any other device capable of communicating with the System or Network. The first and second computing devices may be configured to communicate with other computing devices via a network. The System may also include a third computing device, which may be another computing device (e.g., a server) connected to the network (e.g., the Internet). The third computing device may be configured to receive information from the first computing device. Information from the first computing device may be a service request or product purchase or simple indication that the first vehicle is disabled and, in turn, provides the location of the disabled vehicle. Further, the third computing device may be configured to transmit information to a plurality of second computing devices, owned and managed by Vendors, in response to receiving information from the first device and further, the third computing device may be configured to transmit information from the plurality of second computing devices back to the first computing device such as the request for service has been received and that a particular product, service or general assistance is available for a particular price and in a particular time frame.

Specifically, aspects of the disclosure provide for a computing device, comprising a network interface configured to communicate, via a network (e.g., the Internet and/or any intermediate links), with one or more first and second computing devices and at least one processor. At least one processor may be configured to receive, via the network interface, a service request from a first computing device from the Customer's location or from any other location (e.g. the stranded motorist or vehicle has a device unequipped to communicate with the System so they contact another party to place an order for them); identify one or more UAVs within the particular UAV's travel capabilities to the location of the Customer's location or to the location of the Customer's disabled vehicle and notify the first computing device which Vendors have UAVs capable and available of performing the required delivery most expediently and economically. In some examples, the processor may access, read and write data to a particular memory device.

Aspects of the disclosure further provide a method of handling service requests and notifications that roadside services and products are available from a particular Vendor or plurality of Vendors to the first computer. For example, several Vendors are located in the service area of the Customer. The method may further include notification to the first computer that any number of UAVs, or other vehicles in Vendor(s) fleet, is available. In addition, the method may include receiving a service request for providing roadside assistance to a disabled vehicle within the service area; and identifying all UAVs, and other vehicles, from among the plurality of UAVs, and other vehicles that are both available and capable of arriving to the location of the disabled vehicle expeditiously or within the advertised response time. After identifying all available and capable delivery vehicles the Customer may select, process payment though the Payment Fulfilment Platform and make a service request from the selected Vendor. Also the method may include tracking the chosen UAV and redirecting the Customer to request another UAV if the initial UAV is not on target to meet a predetermined response time. Further, in some embodiments of the System, a response time of, e.g., thirty minutes, may be set to respond to Customers, and the System may offer an alternative method of relief, such as a road based vehicle of human transport or an escort to reach the Customer within the set response time, particularly if a primary UAV is not on target to reach the Customer within the set response time. For example, if a selected UAV is not available and capable of arriving at the location of a disabled vehicle, the System may offer, as an alternative, a road based vehicle capable of human transport to pick up the Customer within the advertised, requested or promised response time or contact a law enforcement agency(s) servicing the region of the Customer to wait with the Customer until the ordered product or service arrives.

Methods and Systems of the above-referenced embodiments may also include other additional elements, steps, computer-executable instructions or data structures. In this regard, other embodiments are disclosed and claimed herein as well. The details of these and other embodiments of the present invention are set forth in the accompanying drawings and the descriptions below. Other features and advantages of the invention will be apparent from the description, drawings, and claims.

### BRIEF DESCRIPTION OF THE DRAWINGS

The present invention is illustrated by way of example and is not limited by the accompanying figures in which like reference numerals indicate similar elements and in which:

FIG. 1 is a block diagram of an example of a plurality of computing devices, the network and the computer System that may be used according to an illustrative embodiment of the present disclosure;

FIG. 2 is an illustrative example that shows how the System accepts and exchanges information between the Customer and Vendor(s) which results in a transaction between the parties with aspects of the present disclosure;

FIG. 3 illustrates an example of how the software may be used to transact an order from the Customer in accordance with the present disclosure;

FIG. 4 illustrates an example of maps indicating the Customer's service location and each available Vendor's service area in accordance with aspects of the present disclosure;

FIG. 5 is a simplified diagram of the features of the unmanned aerial vehicle from FIG. 6;

FIG. 6 is an illustration of the efficiency an aerial based delivery and return method offers all participants transacting on the System.

### DETAILED DESCRIPTION OF THE PREFERRED EMBODIMENT

Although the invention has been described in terms of a specific embodiment, it will be readily apparent to those skilled in this art that various modifications, rearrangements and substitutions can be made without departing from the spirit of the invention. The scope of the invention is defined by the claims appended hereto. Other objects and advantages of this invention will become apparent from the following description taken in conjunction with the accompanying drawings wherein are set forth, by way of illustration and example, certain embodiments of this invention. The drawings, flowcharts and diagrams constitute a part of this specification and include exemplary embodiments of the present invention and illustrate various objects and feature thereof.

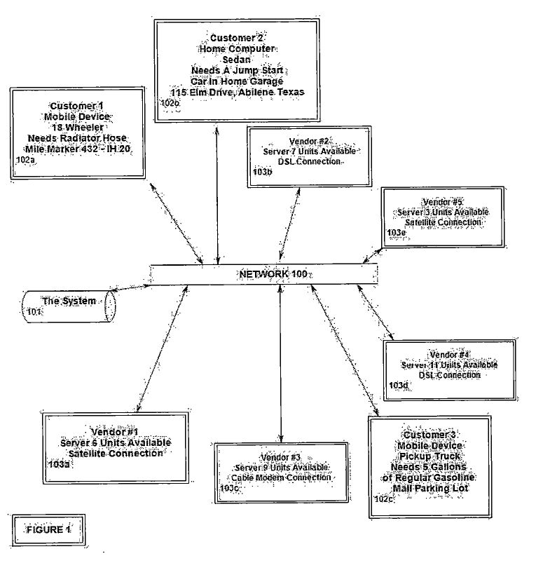

FIG. 1 a block diagram detailing paths of communication, and the resulting transfer of information between Customers, 102a-102c, Vendor's, 103a-103e, the System, 101, and how the Network, 100, facilitates that communication. As the example is illustrated in FIG. 1, several Customers are communicating their locations, needs, and other particulars helpful of their situation to the System, 101, through the Network, 100, where it is disseminated and delivered to a plurality of Vendors, 103a-103e, then said Vendor(s) report back to the System, 101, through the Network, 100, that they have a vehicle or vehicles that are both capable and available of delivering the Customer(s) order. The System, 101, then reports to the requesting Customers, 102a-102c, those Vendors, 103a-103e, who are both capable and available of fulfilling the Customer's order.

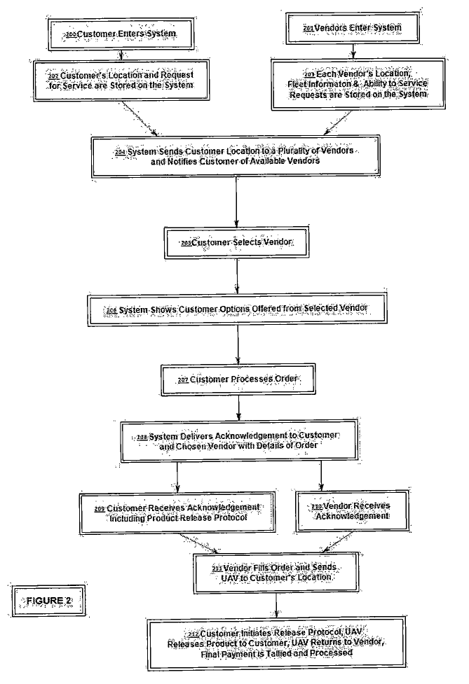

FIG. 2 a flowchart further detailing the scope of information facilitated by the System and Network for both Customers and Vendors. STEP 200: The Customer(s) enters the System. STEP 201: A Vendor or plurality of Vendors also enter the System or, most likely, entered the System previously or remain entered in the System as a perpetual, real time participant(s). STEP 202: The Customer(s) transmit their location(s) and request for service through a mobile device or other device capable of communicating with the System through a Network Connection (e.g. the internet) and in turn the System stores the Customer's information. STEP 203: The Vendor(s) transmit their location, Fleet Information and Ability to Service requests in the Customer's region to the System where that information is also stored. STEP 204: Exchanges stored information between Customer and Participating Vendors. STEP 205: Customer selects Vendor. STEP 206: The System shows the Customer options offered by Selected Vendor. STEP 207: Customer processes, or places, order. STEP 208: System acknowledges to both Customer and chosen Vendor that the Customers order has been placed with the Details of the order. STEP 209: Customer receives acknowledgement that the order has been placed and receives protocol to release the ordered product when it arrives. STEP 210: Vendor receives acknowledgement or order placement. STEP 211: Vendor fills order and dispatches delivery vehicle to location of Customer's choosing. STEP 212: Customer initiates release protocol, delivery vehicle releases product or service to Customer, delivery vehicle returns to Vendor and final payment is tallied and processed.

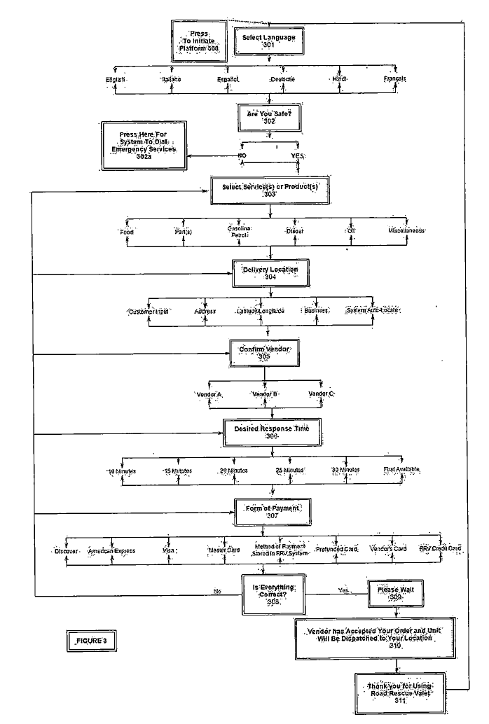

FIG. 3 an example transaction on the Platform. STEP 300: The Customer initiates and enters the Platform. STEP 301: Customer selects the language to process the transaction. STEP 302: System Asks Customer if they are safe. If Customer answers YES then System and Customer proceed to the next step of the transaction in the Platform. If the Customer answers NO then the Customer will be given the choice of instructing the System to initiate communication with Emergency Services (e.g. Call 911). STEP 303: Customer is offered a plurality of products or services. STEP 304: Delivery Location: Customer is prompted to, through a plurality of options, enter a delivery destination. STEP 305: Customer is prompted to select a Vendor. Vendors in this section have reported to the System that they have units available and capable of delivering the items on the Customer's order to the Customer's location of service. STEP 306: Customer is prompted to enter a desired response time for the delivery. STEP 307: Customer is prompted to choose a form of payment. STEP 308: System presents the details of the order and prompts the Customer to confirm that the details presented are correct. If Customer selects the YES option then the process takes the Customer forward to the next Step, step 309. If Customer Chooses the NO option then the System will automatically return to one of the previous steps so the Customer can correct their order. STEP 309: Asks the Customer to wait while the Customer's order is presented to the selected Vendor. STEP 310: Alerts Customer that the Vendor has accepted the order and a delivery unit will be dispatched to the Customer's location as ordered. STEP 311: Thanks the Customer for their patronage.

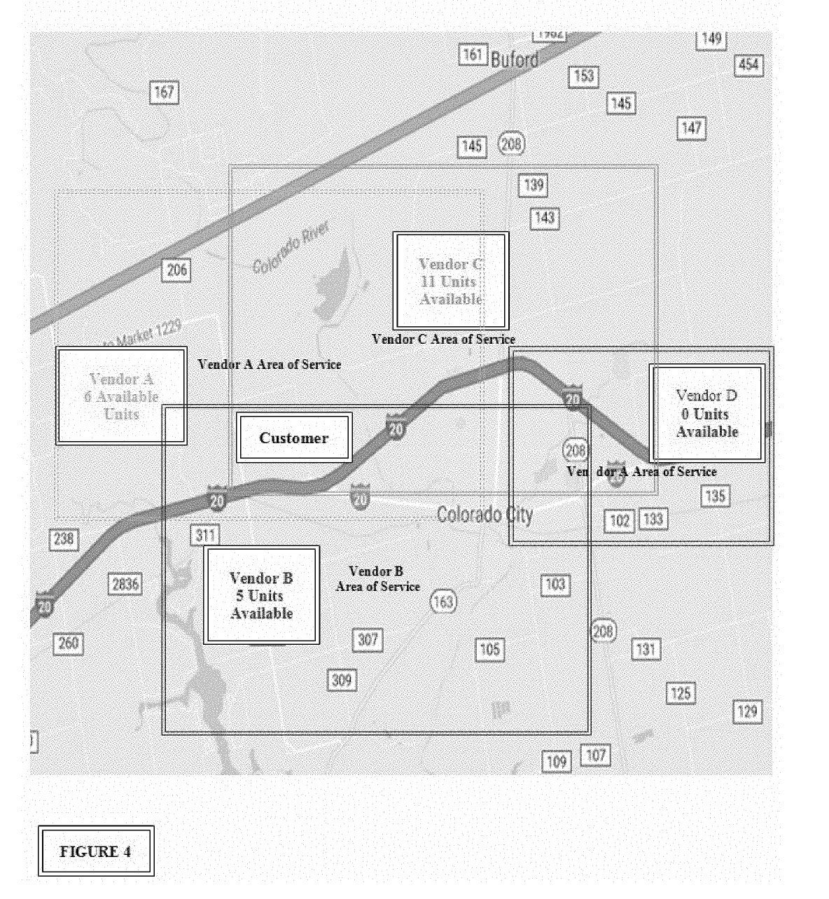

FIG. 4 an illustration contemplating the embodiment of an active map that may be utilized by the System to show all parties the Customer's location, Vendor's service area, Number of Vendor's available Units that Vendor reports are capable and available for service and each Vendor's location in real time. The map will also be capable of showing the delivery vehicles route(s) and real time progress of the delivery and location of the delivery unit.

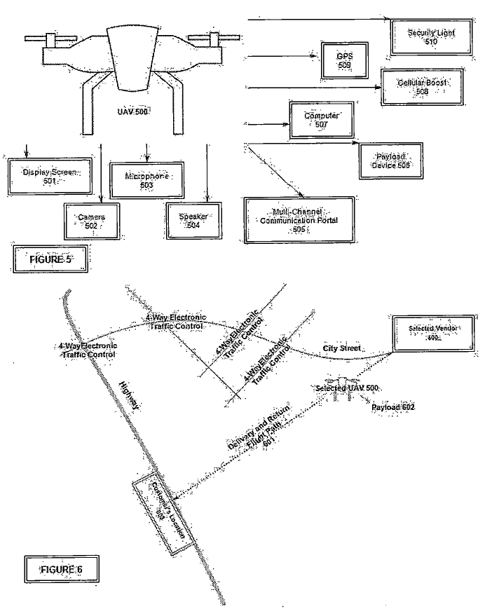

FIG. 5 in the preferred embodiment, the display screen 501, camera 502, microphone 503, speaker 504 and multi-channel communication portal 505, are utilized to facilitate information sharing between the parties. The Payload Device 506 secures, carries and releases the Customer's order as instructed by the on-board Computer 507. In addition, the Cellular Booster 508 increases range and reception for the Customer's cellular communication device(s). The GPS 509 is utilized for guidance, control and continual, real time location information for the delivery unit. It is further contemplated that the security light 510 illuminates the Customer and the Customer's location if delivery/service is required at a time or place where there is little or no other light source.

FIG. 6 it is contemplated in this embodiment that the Vendor selected to fill the Customer's order, herein labeled Selected Vendor 600, delivers the ordered product or service, referred to herein as Payload 602, to the Customer's Location 603. Selected Vendor 600 loads and directs the Selected UAV 500 to Customer's Location 603. Selected UAV 500 travels to and returns from the Customer's location 603 on the Delivery and Return Flight Path 601.

The benefits of the invention, include but are not limited to the following:

The System may produce and deliver a detailed electronic receipt for participants of the transaction.

The System may produce a visual and audio recording of the delivery vehicles encounter with Customer.

Components of the System may provide on-site diagnosis of the vehicle.

Components of the System may facilitate a remote, virtual inspection of the disabled vehicle by device, instrument and/or person skilled in the art of automobile repair.

Components of the System may facilitate computerized repair and/or instruction for repair(s), of the disabled vehicle by device, instrument and/or person skilled in the art of automobile repair.

Components of the System may deliver current and/or stored data to a mechanic or vehicle repair facility as directed by Customer.

Under Customer's direction Components of the System may store and/or utilize and/or distribute the information gathered from past transactions with a particular vehicle regardless of participating vendors.

Provides for a more informed Customer prior to placing the order and a unit being dispatched.

Provides information on additional products and services offered by Vendor.

Displays the approximate cost of service before Customer finalizes, and pays for, the order.

The System may offer corporate Customers a direct billing option for payment of services rendered within a billing cycle.

Improves Customer safety and convenience by providing a superior alternative method of dealing with a disabled vehicle or issues which might arise for a traveler in an unfamiliar or desolate area.

Improves Customer safety by offering to relay Customers location to local law enforcement if Customer feels unsafe.

Allows the Customer to utilize a UAV owned/managed by Customer.

Allows Other Parties to participate in the System as owners/managers of UAV(s) even though they will not provide the Customers requested product(s) and in turn a Provider may participate in the System even though said Provider does not own a vehicle capable and available of delivering the Customer's order.

Video camera can monitor and record Customer's progress and safety from a safe distance until said Customer has resumes operation of vehicle.

Does not contribute to, and in some cases may relieve, traffic congestion.

UAVs are substantially less vulnerable to road conditions and traffic congestion than traditional road based vehicles.

Improves services to foreign Customers.

Components of the System may amplify or boost Customer's cell phone reception.

Delivery vehicle releases the ordered product(s) and/or services(s) to the Customer once the agreed upon release protocol(s) has been satisfied (e.g. voice recognition software, a code exchanged via SMS and/or Automated License Plate Recognition Technology).

Unmanned delivery may be less expensive to own and operate than more traditional human operated vehicles.

Allows Vendors such as gas stations, convenience stores and auto supply retailers to better target advertisement to their prospective Customers.

Enables fuel and auto parts companies to secure corporate/personal service accounts.

Offers local merchants another means to reach prospective Customers.

Reduces the risk of on-site pirating from a vulnerable Customer.

Can serve as an electronic and/or visual beacon to Customer's location.

Increases both Customer(s) and Vendor(s) efficiency.

While the above described embodiments disclose a Unmanned Aerial Vehicle (also identified herein as a UAV) dispatch and a Payment Fulfilment Platform, the invention could readily be used to summon any other type of transportable repair service including but not limited to tow-trucks, automobile service vehicles and vehicles used for human transport. This would involve yet another menu choice of the type of service desired. The System would then request an appropriate vehicle be dispatched to the Customer, or the appropriate vehicle might directly respond via receiving equipment on-board the vehicle. Also, as mentioned above, this automated vehicular requesting service could be used worldwide via on-line connection to the internet or some other board-coverage transmission medium. Alternatively, the user could access the interface software via an internet or telephonic connection whereby the user is cued for information and an appropriate request for a service or product vehicle is processed.

This would allow the user to place a request from half-way across the world for a specific date and time, thereby lessening the extra worry and hassle from the stress of disabled transportation. Foreign travelers are often targets for overcharging and inefficient routing by some relief servicers. By specifically being able to request a vehicle from a chosen company, the user can ignore solicitations from other companies with the security of knowing that their chosen method of relief will arrive as requested.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method as implemented on a computer System for use by a Customer, typically an operator of a disabled vehicle, manned or otherwise, said method for delivering instructional messages to said Customer regarding private Vendor(s) of services and items that may assist Customer and estimate costs for hiring said Vendor to deliver a specific product(s) and/or service(s) to the location of the Customer via a UAV, or another type of vehicle, and a Payment Fulfilment Platform, said method comprising the following steps:
(1) Notifying participating Vendors that Customer has entered the System and discloses Customer's location, or location other than Customers current location, where delivery is desired;
(2) Graphically illustrating the product(s) and/or service(s) offered by Vendor(s);
(3) Displaying a list of participating Vendors, and location(s) of said Vendors on an electronic map or plurality of electronic maps, who are capable and available of providing service(s) and/or product(s) to the Customer's location or to a location of Customer's choosing;
(4) Displaying the approximate cost for delivering the product(s) or service(s) offered to the Customer at the selected destination;
(5) Displaying methods of payment honored by System;
(6) Delivering specifics of Customer's request to the selected Vendor and placing an order to dispatch chosen item(s);
(7) Estimate the approximate arrival time for said delivery;
(8) Customer's order, whether the selected delivery vehicle is owned or managed by the Vendor, whether the selected delivery vehicle is owned or managed by the Customer or whether the selected delivery vehicle is owned or managed by a separate third party or a plurality of participating parties, is processed through the Payment Fulfilment Platform before the order is initiated and loaded onto the selected delivery vehicle and the selected delivery vehicle is dispatched to Customer's location or location of Customer's choice;
(9) Delivery vehicle releases the ordered product(s) and/or services(s) to the Customer once the agreed upon release protocol(s) has been satisfied.

2. The method of claim 1, wherein said messages may be delivered in various foreign languages as selected by the Customer.

3. The method of claim 1, wherein the System offers to contact emergency services if the Customer does not feel safe.

4. The method of claim 1, wherein said destination locations, items offered by Vendor and number of UAVs capable and available to deliver, illuminate when selected on said computer System.

5. The method of claim 1, including the step of displaying additional items for sale or delivery to Customer during the transaction or after the transaction.

6. The method of claim 1, payment for service(s) rendered in the forms of payment acceptable to System will be distributed to Vendor regardless of that Vendor's ability to accept that particular form of payment.

7. The method of claim 1, wherein a confirmation display of the selected options chosen by Customer are presented to Vendor, Customer and any other party participating in the transaction.

8. A method wherein Components of the System provide vehicle diagnosis.

9. A method wherein Components of the System provide vehicle repair and/or instruction for vehicle repair.

10. A method wherein Components of the System stores and/or later utilizes the information of a particular Customer and/or disabled vehicle.

11. A method wherein Components of the System stores and/or catalogues and/or disseminates the information of a particular make and/or model of vehicle.
